(19) United States
(12) Patent Application Publication
(10) Pub. No.: US 2022/0355506 A1
(43) Pub. Date: Nov. 10, 2022

(54) Musical Reed Treatments

(71) Applicant: Daniel Levin, La Canada, CA (US)

(72) Inventor: Daniel Levin, La Canada, CA (US)

(21) Appl. No.: 17/621,441

(22) PCT Filed: Jun. 24, 2020
(86) PCT No.: PCT/US2020/039275

§ 371 Date: Dec. 21, 2021

Related U.S. Application Data
(60) Provisional application No. 62/865,979, filed on Jun. 25, 2019.

(51) Int. Cl. B27K 9/00; B27K 3/08; G10D 9/035; G10D 9/08

(52) U.S. Cl. CPC B27K 9/005; B27K 3/08; G10D 9/035; G10D 9/08

(57) ABSTRACT

Methods of improving reed performance are provided comprising the steps of treating one or more reeds with a solution and cycling the pressure over the solution from atmospheric pressure to reduced pressure to atmospheric pressure.

### BACKGROUND

Musicians who play wind instruments, such as clarinet, saxophone, oboe, bassoon and related musical instruments that rely on exchangeable vibrating reeds to produce the instrument's sounds, typically suffer problems of reed variability and unreliability, both between newly purchased reeds and also through the course of reed use, with need for careful initial reed selection, reed conditioning and then all too short reed longevity before cumulative degradation in reed performance necessitating frequent, economically challenging and frustrating reed replacement.

This is a particular problem with reeds fabricated from natural plant materials such as cane (e.g. from species Arundo donax) due to plant material variability and need to break reeds in by hydration with water or saliva which (in combination with saliva exposure during reed use) causes gradual blockage and/or breakdown of plant tissue and channels within the reeds. The gradual accumulation of water and salivary components within the reed's constituent channels during use over time, adversely affects the performance of the reed (as a consequence of changes in the physical properties of the reed, varying reed density and varying resilience which modify the reed's responsiveness and manner of vibration during use, adversely affecting the range of harmonics, clarity of tone and ability to produce satisfactory or ideal sounding notes throughout the pitch range of the musical instrument using the reed). Some degree of reed hydration or “wetting” is necessary, both to seal the reed to the instrument mouthpiece and more importantly to achieve satisfactory reed performance and consistency during a musical performance, but too much wetting of the reed causes saturation or water-logging for the reed which then adversely affects reed performance. Additionally, if a wetted reed is subjected to dry climate conditions (including excessive air conditioning), warping of the reed (causing distortions in the plane of the reed undermining the air seal with musical instrument mouthpiece) can occur which can then also render the reed unusable.

For good musical tone and responsiveness when playing wind instruments, reeds require a particular range of absorbed moisture, too little moisture causes an unpleasant and unreliable tone whilst too much moisture also compromises the musical performance of the reeds as they then become less responsive due to over-saturation with water and other salivary components introduced during reed conditioning and/or playing the reed to generate musical tones.

Musicians often go to great lengths, first of all to select suitably performing reeds, then to undertake a lengthy break-in period of several days or more, sometimes extending over weeks. This break-in process involves working with a selection of reeds, until satisfactory musical performance is achieved with preferred reeds from the selection; also wetting the reeds with saliva and/or water and playing musical tones over and over before ideal or even just satisfactory reed performance is achieved, discarding or relegating suboptimal reeds whilst rotating between better reeds, both for musical practice and for musical performance. This is because reeds made from natural cane materials vary in their composition and performance characteristics due to reed to reed variation and also, for a given reed, as a function of environmental conditions and their own condition which waxes and wanes over a period of use before accumulation of salivary components within reed channels plus other reed degradation eventually compromises reed vibrational properties, tonality (which is the composition of musical note base frequency plus harmonics) and usability such that reeds then need to be discarded and replaced.

Reed tone (which may be characterized by the blend and relative amplitude of harmonics generated) depends on combination of cane density and resilience or springiness (affecting reed vibration properties). These reed characteristics are in turn affected by the extent of reed vascularization by channels (that originally transported nutrients and moisture within the plant from which the reed was manufactured, ref. P Kolesik, A Mills and M Sedgley, Annals of Botany, 1998, 81, 151-155), plus the level of hydration with saliva and/or water and also the extent to which components from water and/or saliva (such as enzymes, sialic acid, microorganisms, calcium and other salts, and/or even food residues) are deposited within, around and/or upon reeds and their internal architecture or vasculature channels. pH can also affect reed composition and performance.

Preferred reeds which produce clear strong primary overtones (higher frequency harmonics) as seen by Fourier transform frequency analysis of the sound produced (FIG. 1A-J), achieve acceptable performance as these various factors are balanced during break in and use (whilst reeds that do not reach acceptable levels of performance and tone are rejected). Even preferred reeds however go on to suffer inevitable deterioration over time as reed vasculature channels are increasingly blocked or otherwise compromised by salivary components and/or as reeds become over-saturated with moisture, undermining their vibrational properties, the harmonic overtones they produce in the musical instrument and hence the musical properties of the reed and instrument. It is also thought that the structure of the reed (or at least the hemicellulose components within the reed that constitute part of the reed structure) may degrade over time, for example under action of salivary enzymes, water, pH and temperature, further undermining reed physical properties and hence musical performance. Atmospheric/environmental conditions can also have a significant influence on reed properties as dryness or humidity and temperature of surrounding air during reed storage or playing also affect the amount of moisture absorbed, lost and retained within the reed.

Musicians will often employ a small container of water in which they place reeds or dip reeds for reed hydration before use. This water, if not regularly replaced or sterilized can give rise to growth of microorganisms introducing risks of mouth infections, furthermore if reeds are left for too long in such water containers they absorb too much water leaving them saturated and unresponsive or otherwise unusable for playing. Some reed manufacturers package their reeds in hermetically sealed containers to maintain controlled humidity for optimal reed hydration before use but that level of humidity quickly changes according to room humidity in which the reeds are used or stored and moisture exposure through the course of use.

Although reed manufacturers endeavor to categorize reeds according to their physical properties, there is nevertheless significant variability in reed properties and performance, both within a given sales pack of reeds and also over the course of use of the reeds. Musicians will, as a result, typically need to discard a good proportion of the reeds they purchase even before much use of the reeds. Musicians also typically need to rotate between use of the different reeds that are retained as reed performance varies through use, and as a consequence of environmental conditions. Musicians select the best reeds for a given day, with the frustration that short longevity means that even the best reeds have to be replaced after just a few days of active playing.

The combination of these factors causes major challenges for musicians in terms of costs, time, frustration and effort in maintaining, rotating, evolving and repopulating their “stable” or collection of usable reeds, selecting and discarding reeds according to reed performance characteristics, breaking in new reeds before professional use, sometimes adjusting reeds where necessary by scraping away reed material to adjust reed performance, keeping reeds hydrated before and during use, alternating between reeds and tracking the changing characteristics of all reeds to allow judicial selection for different musical performances and indeed also to accommodate changes in surrounding environment such as temperature, humidity, type of music to be played and room acoustics. Professional musicians frequently attest to reed performance being one of their major frustrations, consuming inordinate time and effort in “grooming” suitable reeds and causing considerable cost due to the high proportion of reeds that are disposed of before reasonable lifetime of use, some before use and others as they relatively quickly deteriorate to the point of being unusable.

What is desirable, therefore, is: 1) a more reliable and consistent quality of reeds with optimal or at least improved and immediate predictable and well behaved tonal properties; 2) reeds that do not need hydration (or at least need less hydration) before and during use; 3) reeds which don't suffer such problems of growth of microorganisms on hydration; 4) reeds that require little or no break in before use in musical performance; 5) reeds that are less affected by environmental conditions; 6) reeds that reliably deliver the wide range of pitch that wind instruments can produce, with more reliable and improved desirable tonality (increased harmonics); 7) reeds that last longer, with attenuated rate of deterioration so that musicians can rely on them for longer with less cost and less effort investment to select, groom, rotate and quickly retire a wide multiplicity of reeds; thus affording confidence of having a reliable reed on any given day or circumstance.

Many attempts have been described to try to mitigate or avoid these issues of variable and quickly deteriorating performance of reeds fabricated from natural products. One approach has been to manufacture musical instrument reeds from synthetic materials that are more consistent in composition within a given reed, over time of use, and/or between reeds, than can be achieved with natural products. Such reeds can be made from synthetic polymers or from fiber-reinforced polymer materials to try to emulate good natural-product-derived reeds, examples may be seen with U.S. Pat. Nos. 2,230,933 and 2,919,617. Lég\tilde{e}re Reeds Ltd for example manufacture and market synthetic reeds made out of BPA free polypropylene which they claim mimic the properties of appropriately hydrated damp cane but without the need for preconditioning before playing, without absorbing water, and with durability, lasting for months rather than just the days or weeks of effective use which is typically the case for reeds made from natural cane. Nuvo Instrumental Ltd similarly provide plastic reeds matched to their plastic clarinets marketed primarily for beginner use. All such polymer reeds are generally eschewed by most professional musicians however due to perceived performance and tonal shortcomings compared with natural cane reeds, notwithstanding the frustrations associated with reeds made from natural cane.

Other manufacturers attempt to combine the benefits of natural product tonality with the resilience and stability of polymeric materials by impregnating natural product cane reeds with polymeric materials to prevent or mitigate saliva ingress into the fabric of the reeds and to improve reed stability and performance properties (as, for example, is described in U.S. Pat. No. 1,776,566 also U.S. Pat. No. 3,340,759 also U.S. Pat. No. 3,705,820 and also U.S. Pat. No. 6,346,663) but these too have limited appeal due to their inferior performance attributes compared with well selected and well-conditioned (optimally hydrated) natural product reeds made from cane. Another approach that has been adopted is to coat natural product plant material reeds with polymeric or other water resisting materials to prevent saliva ingress (for example as described in U.S. Pat. Nos. 1,790,167 and 4,145,949) as are, for example, marketed as Plasticover reeds by the D'Addario reed manufacturer who claims brilliant, projecting sound quality from new and improved plastic coating formula for increased durability and weather resistance. Again, however, most professional and many amateur musicians nevertheless prefer selected natural product reeds to these plastic-coated reeds due to the better properties of carefully selected and maintained natural cane reeds, despite the variability and lack of longevity of natural product reeds.

A further approach described in the prior art is to treat natural product cane reeds with other materials to better precondition them than by treating them only with water, as is customarily adopted by most musicians. Thus, U.S. Pat. No. 5,379,673 teaches treatment of reeds with an oxidizing agent such as 3% hydrogen peroxide, in combination with a humectant such as 7% to 8% glycerol in water, often at neutral pH, with claims that this treatment moistens reeds and allows them to remain moist whilst also removing debris from the reeds including associated microorganisms, along with preventing growth of microorganisms. Such treatment alone has however been found to be suboptimal in its effectiveness and of limited longevity as regards reed performance.

EP 2,853,569 B1 teaches treatment of reeds of vegetable origin to improve their musical performance by immersion for between 1 and 15 minutes in extracts of Aloe containing acemannan or glucomannan or mixtures thereof, with or without inclusion of salivary enzymes, with or without hyaluronic acid, triglycerides, Argan oil extracted from Argania spinosa, and with optional inclusion of preservatives. Such methods alone are inefficient at forcing permeation of treatment media into the fabric of reeds and may not achieve adequate long lasting reed performance improvement.

It is generally agreed in some relevant professional musician circles that all of these aforementioned established approaches to improve upon or substitute for natural cane reeds suffer disadvantages in that the synthetic reeds and the polymer treated reeds generally exhibit poor tonal properties (likely due to the increased mass and/or different density and different vibrational properties of such reeds compared with natural cane reeds). Conversely, evaluation of the humectant/peroxide treatment described in U.S. Pat. No. 5,379,673 was found to give reeds with limited benefits over untreated reeds and poor longevity compared with treatment according to the present disclosure.

There is still the need therefore for a superior means of improving and retaining the good tonal properties of natural cane reeds by alternative treatment of such reeds to improve their performance and to mitigate their disadvantages of needing extensive preconditioning and breaking in, along with short longevity before their usable performance characteristics deteriorate, through degradation, reed vasculature occlusion and other causes, compromising the vibrational properties of the reeds e.g. through accumulation of excess water, calcium salts and salivary products.

An additional challenge with musical instrument reeds is to maintain acceptable levels of hygiene to prevent growth of microorganisms and to preclude risk of oral infection for musicians using the reeds or even hypersensitivity pneumonitis arising from infection by bacteria, molds or fungi growing on musical instruments, especially reeds (ref Cormier, Yvon. 2010. “Wind Instruments Lung: A Foul Note.” Chest Journal. 138(3): 467-468 2010, also). Various methods of reed sanitation have been described including use of hydrogen peroxide (U.S. Pat. No. 5,379,673), hand wipes, disinfectant, bleach, alcohol, soap and water, ethylene gas, ultraviolet irradiation and other methods (ref. Marshall, Bonnie and. Levy, Stuart, International Journal of Environmental Health Research, 2011, 21(4), 275-285) but none of these ideal and they don't adequately improve reed performance.

### BRIEF SUMMARY OF THE PRESENT DISCLOSURE

In some aspects of the present disclosure, methods of improving reed performance are provided comprising the steps of treating one or more reeds with a solution and cycling the pressure over the solution from atmospheric pressure to reduced pressure to atmospheric pressure, wherein the solution is an aqueous solution comprising a humectant.

In other aspects of the disclosure, methods for treating musical instrument cane reeds comprising the step of immersing cane reeds in a solution comprising a humectant and a diluent are provided.

In some other aspects of the present disclosure, methods of improving reed performance are provided comprising the steps of treating one or more reeds with a solution and increasing the pressure over the solution from atmospheric pressure, wherein the solution is an aqueous solution comprising a humectant.

In additional aspects of the present disclosure, reeds prepared by the methods of the disclosure are provided.

In still other aspects of the disclosure, musical instruments using reeds prepared by the methods of the disclosure are provided.

In yet additional aspects of the disclosure, methods of playing musical instruments wherein the instrument comprises a reed of the disclosure is provided.

In yet further aspects of the present disclosures, solutions for treating reeds in accordance with the disclosure are provided.

### BRIEF DESCRIPTION OF THE DRAWINGS

FIG. 1A is a chart showing frequency analysis of circa F₅ tone from commercial reed from commercial manufacturer “1”.

FIG. 1B is a chart showing frequency analysis of the same tone as in FIG. 1A, but this time produced using another reed of the same type as used in FIG. 1A from manufacturer “1”, after treatment according to the principles of the present disclosure, showing significantly increased amplitude of higher harmonics at triple the frequency (around 2100 Hz) and quadruple the frequency (around 2800 Hz) of the base note frequency (in this case around 700 Hz), relative to base note circa 700 Hz peak's amplitude, for the treated reed compared with the untreated reed.

FIG. 1C is a chart showing frequency analysis of circa D₆ tone from commercial reed from commercial manufacturer “2”.

FIG. 1D is a chart showing frequency analysis of the same tone as in FIG. 1C, but this time produced using another reed of the same type as from manufacturer “2”, after treatment according to the principles of the present disclosure, showing significantly increased amplitude of higher harmonics at triple the frequency (around 3525 Hz) and quadruple the frequency (around 4700 Hz) of the base note frequency (in this case around 1175 Hz), relative to base note circa 1175 Hz peak's amplitude, for the treated reed compared with the untreated reed.

FIG. 1E is a chart showing frequency analysis of circa D#₄ 312 Hz based note tone from commercial reed from commercial manufacturer “X”.

FIG. 1F is a chart showing frequency analysis of the same tone as in FIG. 1E but this time produced using another reed of the same type as depicted from the same manufacturer “X” after reed treatment according to the principles of the present disclosure, showing significantly increased amplitude of higher harmonics, for example at triple the 312 Hz base note frequency (i.e. the harmonic at around 936 Hz), at quadruple the base note frequency (around 1248 Hz) and at five times the base note frequency (around 1560 Hz), relative to base note circa 312 Hz peak's amplitude, plus additional other boosted higher harmonics for the treated reed compared with the untreated reed, explaining the improved tone characteristics of the treated reed compared with the equivalent untreated reed of the same type from the same box of reeds from the same manufacturer.

FIG. 1G is a chart showing frequency analysis of circa F₅ 703 Hz base note tone from commercial reed from commercial manufacturer “X”.

FIG. 1H is a chart showing frequency analysis of the same tone as in FIG. 1G but this time produced using another reed of the same type as depicted from the same manufacturer “X” after reed treatment according to the principles of the present disclosure, showing significantly increased amplitude of higher harmonics, for example at double the 702 Hz base note frequency (i.e. the harmonic at around 1404 Hz) relative to base note's circa 702 Hz peak's amplitude, plus additional other boosted higher harmonics for the treated reed compared with the untreated reed, explaining the improved tone characteristics of the treated reed compared with the equivalent untreated reed of the same type from the same box of reeds from the same manufacturer.

FIG. 1I is a chart showing frequency analysis of circa A#₅ 935 Hz based note tone from commercial reed from commercial manufacturer “X”.

FIG. 1J is a chart showing frequency analysis of the same tone as in FIG. 1I but this time produced using another reed of the same type as depicted from the same manufacturer “X” after treatment according to the principles of the present disclosure, showing significantly increased amplitude of higher harmonics, for example at double the 935 Hz base note frequency (i.e. the harmonic at around 1870 Hz), and at quadruple the base note frequency (i.e. around 3740 Hz), relative to base note circa 935 Hz peak's amplitude, plus additional other boosted higher harmonics for the treated reed compared with the untreated reed, explaining the improved tone characteristics of the treated reed compared with the equivalent untreated reed of the same type from the same box of reeds from the same manufacturer.

FIG. 2 is a schematic diagram of one example of reed treatment equipment for the first step of reed treatment by impregnating reeds with reed treatment solution as generally used in the Examples.

### DETAILED DESCRIPTION OF THE PRESENT DISCLOSURE

In many embodiments, the present disclosure comprises one or optionally two or more sequential steps for treatment of musical instrument reeds made from natural materials to improve their properties, tonality and longevity. The first step involves permeating reeds with a treatment solution comprising a humectant which may include one or more optional solvents to improve permeation properties of the humectant into and within the fabric of the reeds being treated. The optional second step involves controlled drying to evaporate some, or all, of the solvents used so as to leave the humectant within the vasculature and fabric of the reeds and/or on the surface of the reeds.

Humectants are hygroscopic substances that can be used to retain moisture which can be of benefit for conditioning musical instrument reeds made of natural materials. Such humectants typically contain hydrophilic chemical functionality, such as hydroxyl groups, which have affinity for, and associate with, water by hydrogen-bonding to water molecules. Use of an humectant as one of two components, combined with an oxidizing agent in water, to treat musical instrument reeds, has been described in U.S. Pat. No. 5,379,673 but this approach has been found to be much less effective than the present disclosure described herein, presumably because of poor infiltration of the humectant described in U.S. Pat. No. 5,379,673 into the pores of the reeds, as well as the incompatibility of alcohol humectant such as glycerol, described in U.S. Pat. No. 5,379,673, with oxidizing agents such as hydrogen peroxide (also claimed in U.S. Pat. No. 5,379,673) which can oxidize glycerol to generate potentially genotoxic and other impurities or degradants, especially in contact with iron, iron salts, iron containing materials or other catalysts.

In some embodiments of the disclosure, methods for treating musical cane reeds are provided comprising the step of removing cane reeds from a solution comprising a humectant and a diluent. In these and other embodiments, the cane reeds may be further isolated from the solution such as by, for example, removing from the solution. Once removed, the diluent may be partially or fully evaporated.

In many embodiments, a pressure differential is applied between the reeds and the solution. Such pressure differential may, for example, force the humectants to permeate into the pores of the reeds. Permeation of the reeds may be accomplished by the use of changes of pressure, such as pressure cycling. In such pressure cycling, a vacuum may be applied to the reeds immersed in the solution followed by releasing the vacuum by opening to the atmosphere.

The vacuum may be applied over various time courses. For example, vacuum may be applied incrementally over a period of time between 1 second and 5 minutes, between about 10 seconds and five minutes, between about 30 seconds to 2 minute, or between about 30 seconds to about 1 minute. Slow application, such as at an approximately even rate of vacuum, can help to mitigate warping of treated reeds after completion of the reed treatment process, thus vacuum can be gradually applied over a period of between 1 second and 5 minutes or longer, for example, by gradual opening of a valve between reed treatment apparatus and vacuum pump and/or by making use of a pump that is sized (in terms of pumped gas flow and achievable vacuum) to realize target vacuum over an extended period, but by whatever means are employed, vacuum is often applied slowly and approximately evenly. A flow restrictor can be used to mitigate the rate of application of vacuum and a controlled slow bleed of air or nitrogen gas into the vacuum apparatus can also be used to moderate the severity of vacuum application. With a high capacity vacuum pump capable of pumping multiples of the interior volume of the apparatus over a short time space of less than a minute, a valve can be used to moderate the rate of application of the vacuum, as can other flow restrictors, with or without an air or nitrogen bleed into the apparatus. The vacuum may also be applied without restriction by simply opening the valve between reed treatment apparatus and vacuum pump or by connecting vacuum pump to apparatus without any restriction of flow. The rate at which gas is evacuated from the apparatus and hence the rate at which vacuum is achieved will depend on the volume of the apparatus and the pump capacity and efficiency of the vacuum pump. The magnitude of the vacuum applied may be increased from reiteration to reiteration and in some embodiments more than 28 inches of mercury vacuum is used, measured according to vacuum gauge connected to the vacuum vessel containing the reeds within the reed treatment solution. With atmospheric pressure at around 29.97 inches of mercury, this equates to absolute pressure within the vacuum container (holding reeds in reed treatment solution) of around 2 inches or less of mercury pressure which is equivalent to 5 cm or less of mercury pressure (around 50 torr absolute pressure) which is also equal to less than 68 cm or 27 inches of water pressure or less than 0.067 bar pressure or less than 0.967 psi of absolute pressure within the vacuum container. In many embodiments, the vacuum, at least for the final iteration of the vacuum and release cycle, is 28.5 inches of mercury vacuum or greater vacuum, which is equivalent to absolute pressure within the vacuum container of less than 0.75 psi of absolute pressure (or less than around 40 torr of absolute pressure) within the vacuum container.

In many embodiments, the absolute pressure over the reeds immersed in solution is less than about 75 torr. In these and other embodiments, the absolute pressure may be less than about 70 torr, about 50 torr, less than about 40 torr. In many embodiments, the absolute pressure is between about 10 torr and about 50 torr including, for example, between about 10 torr and about 40 torr.

With lesser pressure over the reeds immersed in solution, the boiling temperature of the solution is commensurately lowered, especially when greater quantities of more volatile diluents are employed to lessen reed treatment solution viscosity, so that with lesser absolute pressure (or higher vacuum) reed treatment must be conducted at lower temperature to prevent boiling of the solution whilst at higher temperatures lesser vacuum must be employed. Thus, for example, with between 5% and 12% ethanol present in the reed treatment solution, a vacuum of around 28 inches to 28.5 inches of mercury is used at ambient temperature of around 20° C.

The vacuum pump may be protected from the vacuum treatment vessel by means of a dreschel bottle in the line between vacuum chamber and vacuum pump oriented to prevent aspiration of reed treatment solution into the vacuum pump. The exhaust of the vacuum pump may be routed through a scrubber or a condenser to prevent emission of volatile solvent diluent or other substances to the air. The whole operation may be conducted in a fume hood to avoid exposure of operators to the materials being used. Safe and appropriate handling of vacuum equipment is well known to those skilled in the art of vacuum operations and handling of chemicals.

For example, treating reeds can be achieved with solutions of the present disclosure and evacuation of reed pores by application of high vacuum as set forth herein, followed by release of vacuum by opening a valve to allow ingress of atmospheric air, or nitrogen gas, to drive treatment solution into the previously evacuated reed pores. This is often done slowly in a controlled manner and may be done through an in-line filter.

The procedure of application of vacuum and release of vacuum may be repeated, for example, until reed pores are no longer able to take up further solution. This may be determined, for example, by weighing after drying. Substantive saturation of reed pores with reed treatment solution is also evidenced by subsequent cessation or lessening of vigorous bubbling when vacuum is subsequently applied. The vacuum may be held for several minutes followed by vacuum release over a period of a minute or so (often between half a minute and two or three minutes). The cycles of alternating ideally slow and controlled application of vacuum to suck air out of the reed pores followed by slow and controlled release of vacuum as set forth herein may be repeated, for example, until little bubbling or frothing of air or other gases is evident from the reeds as each vacuum cycle is applied which implies that the pores of the reeds have by then become saturated and impregnated by the reed treatment solution. In some embodiments, this may take 3, 4, 5, or more cycles. For larger reeds, such as tenor saxophone reeds, 5 or more cycles may typically be applied, and for smaller reeds such as clarinet reeds, fewer cycles may achieve the same results.

Depending on the vacuum used, one may vary and control the number of vacuum cycles. For example, absolute pressures of less than about 50 torr may be used. In many embodiments the absolute pressure is about 10 torr and in other embodiments it is between about 10 torr and about 50 torr. Lesser vacuum can be used effectively if combined with additional reiterations of the vacuum application and vacuum release cycle. In the cycles, the vacuum may optionally be maintained prior to release for some period of time. Between 1 and 10 vacuum applications and slow vacuum release cycles may be used although, depending on the viscosity of the reed treatment solution used, as little as 2 cycles can be sufficient with low reed treatment solution viscosity achieved as a result of higher dilution and/or higher temperature.

The release of vacuum may be to ambient pressure such as opening to atmosphere or an inert gas source such as nitrogen or argon. In other embodiments, the release may be to pressures that are below atmospheric pressure with such opening, but maintaining a lower than atmospheric pressure with, for example, a vacuum pump such as to pressures of between about 15 and about 50 torr in some embodiments.

In many embodiments, 3 to 4 cycles of vacuum application and vacuum release are used to ensure thorough permeation of reed treatment solution into the pores of the reeds with reed treatment solution viscosity between about 1 centipoise and about 150 centipoise including between about 1 centipoise and about 50 centipoise at around ambient temperature such as about 20° C. Other ranges include between about 1 centipoise and about 10 centipoise, between about 10 centipoise and 20 centipoise, between about 20 centiposie and about 30 centipoise, between about 30 centipoise and 40 centipoise, and between about 40 centipoise and 50 centipoise. Release of vacuum by opening of a valve to allow ingress of atmospheric air or nitrogen may be conducted slowly to allow the reed treatment solution to permeate the pores and vasculature of the reeds. For example, vacuum can be released slowly over a period of between 30 seconds and 5 minutes, typically releasing vacuum at an even rate over a period of between 45 seconds and 2 minutes per iteration of the vacuum application and vacuum release cycle.

More viscous treatment solutions flow less easily, quickly and extensively into the reed vasculature (driven by diffusion and application of differential pressure, whether application of external pressure or release of vacuum), hence more iterations and slower release of vacuum is required with more viscous reed treatment solutions having greater glycerol content or other humectant content or less diluent content, up to the viscosity of pure glycerol of around 1000 centipoise at around 20° C., hence too the need for ethanol or water or other diluent to reduce the viscosity of the reed treatment solution containing the humectant to help it flow more readily into the reed vasculature so that fewer iterations of vacuum then atmospheric pressure or else elevated pressure are needed to force the reed treatment solution into the reed vasculature. More viscous reed treatment solutions, such as those with less solvent. may require further iterations and slower release of vacuum to achieve efficient permeation of reeds by reed treatment solution.

Temperature control can also be used to influence treatment solution viscosity since the viscosity of the solution decreases at warmer temperatures. However warmer temperatures also increases the vapor pressure of low boiling diluent such as ethanol increasing frothing or boiling of that component as vacuum is applied. Temperature can be controlled between around 0° C. and around 50° C. with higher temperature facilitating lesser treatment solution viscosity for more efficient permeation of treatment solution into reed pores, however temperature is preferably controlled between around 10° C. and around 30° C. and most preferably between around 15° C. and around 25° C. which can be managed by control of ambient temperature or by a controlled temperature bath or other temperature controlled chamber around the reed treatment apparatus. Evaporation of the diluent at higher temperatures may increase problems of treatment solution frothing which can be mitigated by operating at a lower temperature. Evaporation of the diluent will also cause some cooling of the reed treatment solution if external heating is absent which will help to mitigate frothing

Once the vacuum application is complete, in many embodiments the vacuum is maintained prior to vacuum release. In many embodiments, the vacuum is maintained for between about 1 second and 1 hour or between about 10 seconds and 10 minutes, after which time, the vacuum may be released. When the vacuum is released, it may be done over a time period such as, for example, between about 10 seconds to about 5 minutes. In many embodiments, the release of vacuum is at an approximately even rate.

The extent of vacuum that is applied and the rate that it is applied can be moderated to mitigate frothing of the reed treatment solution as bubbles are expelled from reeds, such as during the first vacuum cycle. The connection to the vacuum pump of the vacuum chamber (containing reeds in reed treatment solution) can be maintained although the vacuum chamber may alternatively be isolated from the vacuum pump once the chamber is evacuated or the vacuum can be maintained via a connection between the source of vacuum (such as a vacuum pump) and the solution where the cane reeds are immersed. The source of vacuum may be any suitable vacuum generating device such as a vacuum pump as disclosed herein.

The reed treatment solution may be tapped or vibrated to facilitate disengagement or release of bubbles from reeds being treated so as to make the reeds less buoyant and also to better separate the air sucked out of the reeds from the reeds, and to better facilitate contact of the reed treatment solution with the reeds. This disengagement of bubbles from the reed surface can also help to prevent air or other gases being forced back into the reed vasculature and pores as vacuum is released when atmospheric pressure is allowed back into the apparatus. Placing the container holding the reeds in the reed treatment solution and/or the vacuum chamber at an angle of between 10 degrees and 45 degrees, including, for example, 25 degrees to 35 degrees from horizontal can also be used to help encourage bubbles of gas sucked out of the reeds under vacuum to disengage from the surfaces of the reeds so that the bubbles are not then pushed back into the reed pores when the vacuum is released by admission of atmospheric pressure to the vacuum chamber used to treat the reeds.

In some embodiments, the durations of vacuum application, vacuum release as well as the desired number of reiterations of the vacuum application and vacuum release cycle can be determined by accurate weighing of reeds to determine when maximum impregnation of reed cavities, pores and vasculature is achieved, as measured by diminishing returns from further durations and further iterations, when reed weight no longer increases with further treatment. Reeds can be weighed when wet (after drying off extraneous external reed treatment solution with an absorbent cloth, paper, towel or lint-free cloth), after subsequent air drying, and/or after reed drying for example using a food desiccator or other drying equipment with correlation of dried reed weight increase (over pre-treatment weight) with reed treatment conditions, durations and reiterations. Thus, for example, reeds may take on between around 15% and around 22% weight after the solution treatment before thorough drying which can then reduce to a weight gain of between about 5% and about 13% after thorough drying, for example using a food desiccator or a vacuum oven or after leaving to air dry in warm or dry conditions. It may be helpful to dry the reeds slowly to prevent them becoming warped which otherwise compromises their ability to seal to musical instrument mouthpieces when in use. Thus drying of the more volatile components of the reed treatment solution can be beneficially undertaken by slow air drying under warm conditions of between around 55 Fahrenheit and 80 Fahrenheit or preferably between around 60 Fahrenheit and 70 Fahrenheit with relatively low atmospheric humidity below around 50% relative humidity. Avoidance of direct sunlight during drying can be helpful to prevent rapid drying and warping of reeds. Drying of the reeds after treatment and air drying can also be further progressed by use of a food desiccator or similar apparatus which propels a warmed air flow round the reeds by a fan. Completion of drying of treated reeds can be undertaken using a food desiccator set to heat to around 80 Fahrenheit to 100 Fahrenheit or preferably between around 85 Fahrenheit and 95 Fahrenheit for between 8 hours and 24 hours or longer, preferably between around 10 hours and around 16 hours, depending on the size of the reeds being treated and dried. Longer drying times are generally needed for larger reeds. Reweighing the reeds through the course of such drying operations helps to determine when diminishing returns are reached with little further loss of weight for each further hour of drying time. Humidity may also be controlled during reed drying to help progress the drying operation, thus use of an air conditioning unit may be employed to reduce humidity significantly below 50% relative humidity to expedite drying. The reeds may also be dried using a vacuum oven or a heated oven without the forced circulation air stream that is typically employed in a food desiccator apparatus. Drying conditions are chosen to ensure removal of a good portion of the more volatile diluent component(s) of the reed treatment solution whilst retaining the majority or all of the humectant and other less volatile components of the reed treatment solution present in the pores of the reeds being treated.

A more viscous reed treatment solution requires more processing (more duration of processing steps and more iterations of all of the steps of impregnation with reed treatment solution), a less viscous reed treatment solution (for example with higher levels of diluting solvent or solvents) requires less treatment duration and less iterations however too much dilution of the humectant with the diluting solvent or solvents leaves less humectant in the reed after the drying step to remove excess solvent or solvents so that the optimal conditions of duration of processing steps and number of iterations must be determined for each choice of humectant and solvents to adjust for the chemical and physical properties of each system chosen, using weight increase (compared with pre-treatment reed weight) as a measure of reed treatment solution ingress into reeds and using ultimate dried reed weight increase (compared with pre-treatment reed weight) as a measure of humectant left in the reed after evaporative removal of solvents during the drying step.

Full immersion of reeds in treatment solution may be achieved, for example, by weighing reeds down, for example by applying metal clips and weights and/or by placing reeds within weighted cages or cages that are fabricated from materials that are compatible with and do not float in treatment solutions but that nevertheless allow circulation of reed treatment solution around and within the reeds being treated. A convenient option is to use clarinet reed holders that have been weighted with metal paper binder clips or other weights.

In other embodiments, a reduction in solution viscosity may be achieved by changing the composition of the solution to facilitate efficient permeation of solution into reed pores but not so dilute as to cause delivery of insufficient humectant into the reed pores such that insufficient humectant remains after evaporative drying following humectant absorption by the reeds. Diluents are typically non toxic. Diluents should be sufficiently volatile such that they may be substantially removed during drying after reed treatment using reed treatment solution however with efficient drying and diligent checking of residual diluent levels in reeds after drying to avoid risk of toxicity, other diluents may also be used such as methanol, methyl formate, methyl acetate, ethyl acetate, isopropanol and others.

In other embodiments of the present disclosure, a second step of applying controlled conditions of temperature, air flow and humidity to achieve appropriate evaporative drying of volatile components from reeds after humectant absorption by the reeds as an alternative to passive drying in air are provided. This can help to ensure that the reeds are efficiently preconditioned with an appropriate composition of humectant present within the reeds, obviating the need for extensive conditioning of reeds with water and/or saliva prior to playing that is otherwise required for typical commercial reeds not treated according to the principles of the present disclosure.

In these and other embodiments, one or more antiseptic components may be added to the solution to inhibit growth of mold or other microorganisms in or on humectant-treated reeds although the humectant itself in concentrated form in reeds treated according to the present disclosure is also beneficial in prevention of microorganism growth. Suitable antiseptic components include commercially available antiseptic mouthwash formulations such as Listerine™ or equivalents, commercially available solutions of chlorhexidine antiseptic may also be used such as Corsodyl™. Other commercially available oral antiseptics may also be used such as Betadine™ povidone iodine, carbamide peroxide formulations such as Cankaid™ or Glu-Oxide™ oral antiseptic, hydrogen peroxide such as commercially available Colgate Peroxyl™ solution, sodium perborate solution and other equivalent materials.

Humectants are typically hydrophilic materials. Humectants may often have a vapor pressure less than the vapor pressure of water. Any of a variety of humectants may be used, individually or in combination, including propylene glycol, glycerol, di-ethylene glycol, carboxymethylcellulose, pectin, aqueous solutions of sugars and other materials including natural sugars, artificial sugars, monosaccharides, disaccharides, sorbitol, corn syrup, high fructose corn syrup, alpha hydroxy acids, egg components, glyceryl triacetate, natural honey, molasses, polyols such as polydextrose, bark extracts, xylitol, maltitol and other materials demonstrating ability to achieve liquid composition, dilution to mitigate viscosity, lack of prohibitive toxicity at the levels present in treated reeds, ability to permeate reed structure, effective reed conditioning properties and low volatility so that the humectant is not subsequently lost during reed drying. A further criterion of importance in humectant selection is one of mitigating microorganism growth in treated reeds to avoid the risk of oral infections for musicians using the reeds. The high osmotic pressure of humectant treatments left in treated reeds after drying to remove much or most of the solvent or diluent component of the treatment solution can help maintain conditions preventing microorganism growth as can the inclusion of oral antiseptic materials in the reed treatment solution. Amongst a variety of humectants evaluated, glycerol, such as, for example, food grade glycerol, has been found to provide a good combination of properties although the reed treatment solution composition can be modified to accommodate additional or alternative humectants, for example by adjusting concentration and dilution with water and ethanol cosolvents to achieve appropriate reed treatment solution viscosity for efficient solution permeation into reed pores during slow vacuum release after vacuum application, whilst reeds are held submerged in reed treatment solution.

A variety of diluents may be used for moderating humectant viscosity to allow efficient permeation into reed pores whilst reeds are immersed in reed treatment solution and vacuum is reiteratively applied and released. Such diluents are typically hydrophilic. The diluent may be water miscible if the humectant is a water-soluble material although a solution of humectant into non-aqueous media is also feasible. The diluent typically has a higher vapor pressure than the humectant and will preferentially evaporate with respect to the humectant. In many embodiments, the diluent has a higher vapor pressure than water. Different combinations of water and ethanol have been developed and found to be efficient for viscosity moderation of humectant solution to allow efficient permeation into reed pores under reiterated vacuum and vacuum release whilst reeds are submerged in treatment solution. Water content for reed treatment solution of between 0% and 50% volume/volume of reed treatment solution volume has been found to be acceptable although water content is often between 0% and 25% v/v of reed treatment solution overall volume. Ethanol content for reed treatment solution of between 0% and 50% of reed treatment solution volume has been found to be acceptable although ethanol content is often between 0% and 25% of reed treatment solution volume.

Reeds may be treated using the reed treatment solutions of this present disclosure at a variety of different temperatures, for example between 0° C. and the boiling temperature of the solution around 85° C. to 100° C., depending on solution composition and vacuum applied, although it is typical to use reed treatment solution at temperature between 10° C. and 40° C. and often at room temperature of around 20° C. Higher temperature aids permeation of solution into reed channels due to reduced viscosity of reed treatment solution however reed structure can also be compromised at higher temperatures and solution boiling becomes a problem at higher temperatures once vacuum is applied, depending on reed treatment solution composition. Hence reed treatment solution temperatures are often between 10° C. and 25° C. which can be maintained by temperature control or temperature can be allowed to drop through the course of reed treatment as volatile diluent evaporates to some degree once vacuum is applied.

De-gassing of reed treatment solution and/or its components may be helpful to mitigate frothing that can otherwise occur when vacuum is applied to the reed treatment system compromising solution and immersed reeds. De-gassing of the solution and/or its individual components can be achieved by heating and/or application of vacuum to the solution and/or its components or mixtures of components. Frothing of reed treatment solution can be mitigated by addition of defoaming agents to the reed treatment solution before or after introduction of reeds. Suitable defoamers are well described and well known to those skilled in the art of chemicals handling and manufacture and can, for example, include anti-foam silicone products marketed by Bevaloid and Elkem. A suitable option is to use a drop or two of a Silcolapse™ product available from Elkem which comprises a mixture of polydimethylsiloxane oil and silica.

The number of reeds that may be treated using a given volume of reed treatment solution is limited primarily by the scale and design of the equipment used to ensure reed submersion in reed treatment solution, to allow for disengagement of bubbling from reed treatment solution and the ability to achieve good exposure of reeds to the solution without occlusion of one reed by another preventing impregnation of reeds by solution. Many different designs of reed and solution containers may be adopted, the principle being to ensure efficient submersion and exposure of reeds to the surrounding solution. Reeds may be weighted or may be caged in weighted caging that keeps them immersed in the solution. The solution may be circulated or agitated by swirling, by tapping the reed treatment container to dislodge bubbles or by active motorized stirring of the solution between and around the reeds. A solution volume of around 200 ml is sufficient to treat between 1 and 30 or more reeds but more typically between 1 and 10 reeds are treated with around 200 ml of reed treatment solution.

The reed treatment solution may be discarded after use or may be reused. If reused then it may be reconstituted by addition of one or other components to regain its original composition. The composition of the solution may be checked using quantitative gas chromatography analysis whose principles are familiar to those skilled in the art of chemical analysis. Another way to monitor the composition of the solution is by measurement of solution viscosity. Typically, the reed treatment solution is used only once to prevent loss of components during use and to avoid build up of chemical components extracted from reeds or to avoid solution degradation for other reasons. This too can however be monitored by quantitative gas chromatography analysis and/or viscosity if solution reuse for improved production economics efficiency is desired which can be achieved by adding volatile and/or other components to re-attain desired solution composition before re-use, thus (for example) additional ethanol can be added to re-attain desired solution composition before re-use, although the reed treatment solution components used are of relatively low cost compared with the cost of the reeds being treated

A further aspect of diluent selection is to ensure efficient evaporation of some, or all, of the diluent components during evaporative drying after treatment of reeds using reed treatment solution, leaving some or most of the humectant within the reeds. Prior to evaporation, excess solution may be removed from the cane reeds after removing or isolating from the solution. This evaporative drying step may be achieved by passive drying through leaving treated reeds to dry in air under ambient temperature conditions or (optionally) by active drying under better controlled conditions of temperature, air humidity and air flow. The reed drying step is to yield reeds whose properties are beneficially moderated by humectant, with humectant thereby better immobilized or retained within reed structure and without a surplus of diluent components which can otherwise compromise reed properties. Thus, reeds that were treated but not subsequently adequately dried were found to feel “heavy” when played in musical instruments whereas a limited extent of evaporative drying under controlled conditions gave beneficial results. Drying may be done at temperatures above ambient temperature. Drying of freshly treated reeds typically comprises removal of excess liquid after treatment by wiping with an absorbent cloth or paper towel, followed by evaporation of volatile components by drying, first by passive drying in air and then by placing into an actively circulated heated air stream at warm temperatures of between about 15° C. and 40° C., and also including between about 25° C. and 35° C., and may also include between about 30° C. and 50° C., often under conditions of controlled ambient humidity of less than about 80% RH and including less than about 60% RH, over a drying period of between 2 hours and 60 hours and including between 5 hours and 30 hours. Hotter and/or drier (less humid) conditions and use of reduced pressure can also be utilized to accelerate drying duration. Drying under conditions of lower humidity allows for lesser temperature and/or shorter drying time. The process of drying can be monitored by monitoring the weight of the treated reeds through the course of drying. Drying may progress until the rate of weight loss over time drops. Thus, reeds that are freshly removed from reed treatment solution, with extraneous treatment solution removed by absorbent cloth, have typically absorbed around 15% to 20% treatment solution by weight compared with original untreated commercial reed weight. This weight increase drops by around 1% or so after 2 hours of passive drying in air, it drops further to around 10% to 15% weight increase (compared with untreated original commercially supplied reed weight) after 14 hours of drying in a food desiccator at 90 F (under conditions of around 60% to 80% ambient relative humidity). While the drying may be done in a food desiccator, other chambers may also be used. In such chambers, typically, air is circulated and heated and the chamber is under temperature control. Note however that the relative humidity experienced at the elevated temperature of around 90 F or around 32° C. within the food desiccator drying chamber is considerably lower, at around less than 40% relative humidity, when ambient air relative humidity is around 80% at around 20° C. ambient temperature). Further drying in the food desiccator for additional 12 h to 36 h will drop the weight increase (compared with original untreated commercially supplied reed weight) by a further 5% or so but reed performance was then less good along with increased risk of reed warping. Hence too much drying time or too high a drying temperature can compromise the effectiveness of the reed treatment by over-drying the treated reeds leading to compromised performance and physical distortion from over-drying. In many embodiments, the drying process removes diluent but does not substantially remove humectant within the reeds.

Permeation of the reeds may be accomplished by the use of high pressure. For example, the reed treatment solution may be pressurized by pressurizing the solution into the pores of the reed by application of air or hydraulic pressure and directing the flow of the reed treatment solution either through the reed by sealing a pipe to the fat end of the reed by means of rubber tubing and clamps or other means, and using between 0.1 bar and 10 bar of pressure above atmospheric pressure to force the solution through the reed.

In other embodiments, the reeds are immersed in reed treatment solution and then placed in a container in a pressure chamber to allow application of air or nitrogen pressure to the chamber to force the solution into the reeds using pressure of between 0.1 bar gauge and 50 bar gauge, including between 0.5 bar gauge pressure and 1 bar gauge pressure. The pressure is applied for a period of between 1 minute and 10 minutes, including 5 to 6 minutes and is then released over a period of between 1 second and 5 minutes, including over a period of 1-2 minutes. The procedure of pressurization and pressure release is then reiterated from 2 to 10 times, such as 3 to 5 times to ensure complete impregnation of reed by reed treatment solution. This can be monitored by weighing of reeds to determine when no further solution uptake occurs.

The optional second step of reed treatment, which comprises drying of reeds after reiterated treatment in reed treatment solution, may be effected using trays in a flow of temperature controlled air, such as may be afforded by use of commercially available food dehydrator equipment. Reed drying may also be carried out using a temperature-controlled vacuum oven. Humidity control may also be utilized.

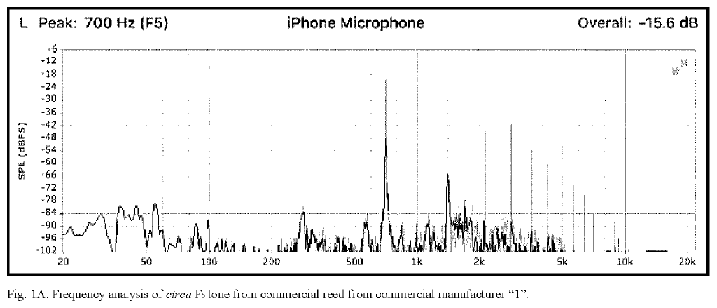

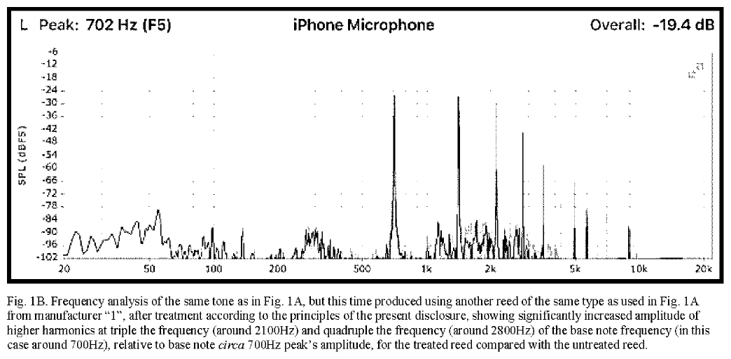

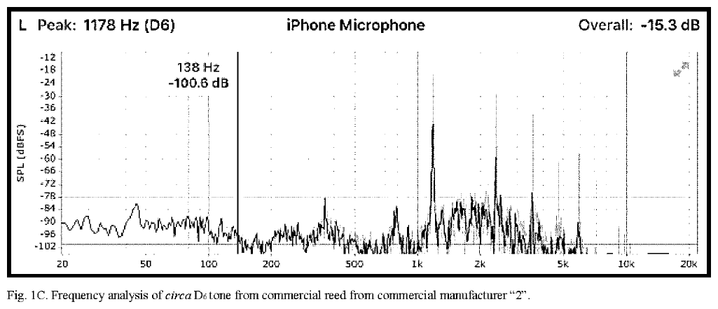

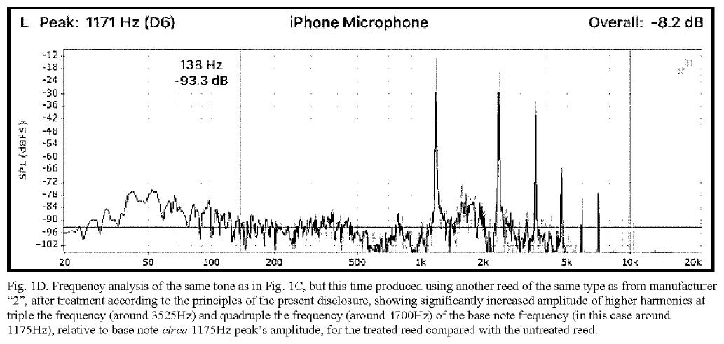

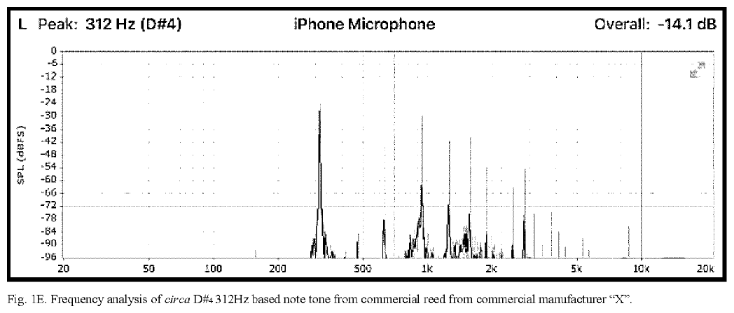

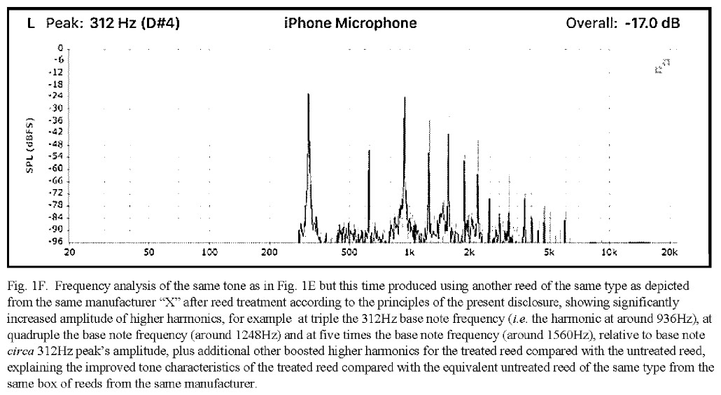

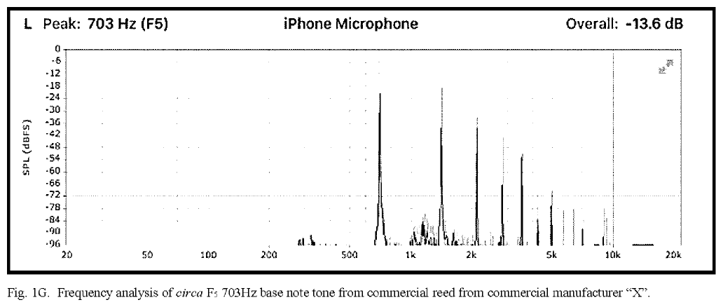

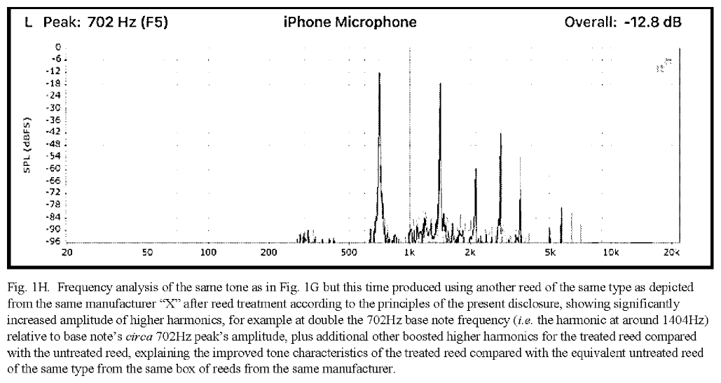

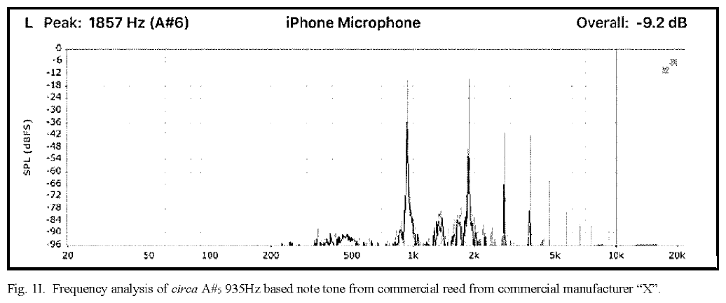

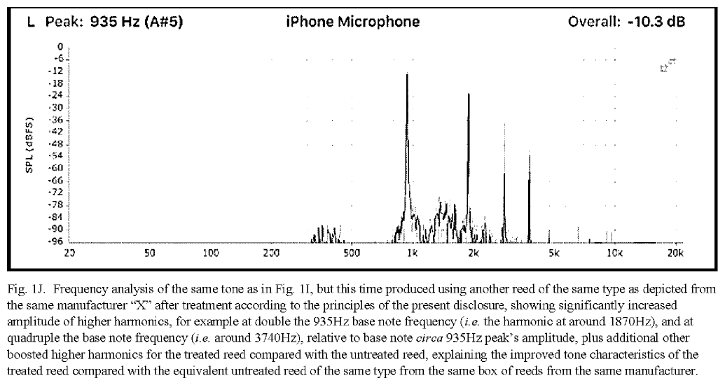

Reeds treated according to the principles and process of the present disclosure give sounds that are described by professional musicians as being richer, rounder and more full-bodied, with excellent response and homogeneity between notes and registers along with improved ease of playing in the altissimo register on a clarinet. Commercial reeds that have not been treated according to the principles and process of the present disclosure give sounds that are described as being somewhat muffled whereas the sounds from reeds treated according to the present disclosure are described as being cleaner. Also the sound of untreated commercial reeds is described as being more uneven between notes and especially between registers. The same reeds treated according to the principles and processes of the present disclosure demonstrate the many advantages described above in this patent document as well as the sound frequency analysis benefits correlating with improved sound quality from stronger (higher amplitude) overtones (compared with untreated reeds of the same type and source) that can be seen from the Fourier transform frequency analysis data presented in FIG. 1.

FIG. 1A-J—Fourier transform (FT) frequency analyses of sounds from treated and untreated reeds, played on a Bb Buffet R13 Prestige clarinet with Clark Fobes 10K mouthpiece by Mr Gary Bovyer (principal clarinet, Hollywood Bowl Orchestra and Long Beach Symphony Orchestra), analyzed using Onyx 3's FFT Plot Sound Frequency Analyzer RTA app on iPhone.

The benefits of the methods of treatment of natural product reeds according to the present disclosure include eliminating the need for much if any break-in period such that reeds can be played right away without the problems of over-saturation common with commercial reeds that have not been treated according to the present disclosure. The treatment according to the present disclosure avoids the need to soak reeds before playing, other than for a superficial wetting and mitigates the problems of reed warping that are caused by (a) repeated wetting and drying that is generally necessary with untreated commercial reeds and (b) the ill effects of dry weather and swings in humidity on reed musical performance. The present disclosure further eliminates the problems of reeds drying out when the musical instrument is left sitting, for example on-stage, between periods of playing.

The processes of the present disclosure on reeds further mitigates the swelling of the back of the reed into the mouthpiece opening as the reed ages that is typical with untreated commercial reeds as they absorb moisture and swell during use and improves tonality with more complete resonance and overtone series, attractive darkening of tone (especially in chalumeau register on clarinet), suppression of tendency of reed to “sizzle” and improvement in ease of playing in altissimo register.

Analysis of sound produced by commercial reeds treated according to the present disclosure (compared with the sound from untreated commercial reeds) using Fourier transform frequency analysis software showed that the reeds treated according to the present disclosure consistently demonstrated increased volume for many of the overtones of the fundamental note played by the clarinet, without changing the overall volume of the instrument (compared with the sound from equivalent untreated commercial reeds). This added resonance improves the timbre of the instrument giving it a richer tone. FIG. 1A-J—Fourier transform (FT) represent frequency analyses of sounds from treated and untreated reeds, played on a Bb Buffet R13 Prestige clarinet with Clark Fobes 10K mouthpiece by Mr Gary Bovyer (principal clarinet, Hollywood Bowl Orchestra and Long Beach Symphony Orchestra), analyzed using Onyx 3's FFT Plot Sound Frequency Analyzer RTA app on iPhone.

Furthermore, treatment of reeds as described by the present disclosure gives reeds that are playable for much longer before reed failure than occurs with equivalent untreated commercial reeds, and give superior tone compared with equivalent untreated commercial reeds. A further advantage is that reeds treated according to the present disclosure are more resilient to saturation with water as evidenced by reeds left soaking in water for 2 hours or more still being fully usable and playable with good characteristics whereas untreated reeds left in water for this length of time are generally unusable due to oversaturation by water. Without being bound by theory, this is likely explainable by the hydrophilic cavities in untreated reeds that can take up water being conditioned by humectant from the reed treatment solution that then both keeps the reed playable but also prevents significant further water uptake. Accordingly, it is within the present disclosure musical instruments containing the reeds of the disclosure and methods of using said reeds of the disclosure with musical instruments.

### Clauses

The following clauses represent various embodiments of the disclosure and are not meant to be limiting.

Clause 1. A method of treating musical instrument cane reeds comprising the step of immersing cane reeds in a solution comprising a humectant and a diluent.

Clause 2. The method of clause 1, further comprising the step of isolating the cane reeds from the solution.

Clause 3. The method of clause 1, further comprising the step of removing the cane reeds from the solution.

Clause 4. The method of clauses 1-3, further comprising the step of evaporating at least some of the residual diluent from the cane reeds.

Clause 5. The method of clause 4, wherein the cane reeds are isolated from the solution.

Clause 6. The method of clause 4, wherein the cane reeds are removed from the solution.

Clause 7. The method of clause 1, wherein a pressure differential is applied between the reeds and the solution.

Clause 8. The method of clauses 1-7, wherein the solution is forcibly permeated into the pores of the reed.

Clause 9. The method of clauses 7-8, wherein the pressure differential is achieved by applying a vacuum to the reeds immersed in the solution followed by releasing the vacuum.

Clause 10. The method of clause 9, wherein the release of vacuum occurs by exposing the reeds immersed in the solution to atmosphere.

Clause 11. The method of clauses 9-10, wherein the vacuum is applied over a period of from about 10 seconds to about 5 minutes.

Clause 12. The method of clause 11, wherein the vacuum is applied at an approximately even rate.

Clause 13. The method of clauses 11-12, wherein after the vacuum application is complete, the vacuum is maintained for between about 10 seconds to about 10 minutes.

Clause 14. The method of clause 13, wherein the vacuum is actively maintained through a connection between a source of vacuum and the solution wherein the cane reeds are immersed.

Clause 15. The method of clause 13, wherein the solution containing the cane reeds is isolated from a source of vacuum.

Clause 16. The method of clauses 14-15, wherein the source of vacuum is a vacuum pump.

Clause 17. The method of clauses 9-16, wherein the vacuum is released over a period of between about 10 seconds to about 5 minutes.

Clause 18. The method of clause 17, wherein the vacuum is released at an approximately even rate.

Clause 19. The method of clauses 9-18, wherein the absolute pressure over the reeds immersed in the solution is less than about 75 torr.

Clause 20. The method of clause 19, wherein the absolute pressure over the reeds immersed in the solution is less than about 70 torr.

Clause 21. The method of clause 19, wherein the absolute pressure over the reeds immersed in the solution is less than about 50 torr.

Clause 22. The method of clause 19, wherein the absolute pressure of the reeds immersed in the solution is between about 10 torr and about 50 torr.

Clause 23. The method of clauses 9-22, wherein the application of vacuum and releasing of vacuum is repeated.

Clause 24. The method of clause 23, wherein application of vacuum and releasing of vacuum is repeated once.

Clause 25. The method of clause 23, wherein the application of vacuum and releasing of vacuum is repeated more than once.

Clause 26. The method of clause 23, wherein the application of vacuum and releasing of vacuum is repeated two times.

Clause 27. The method of clause 23, wherein the application of vacuum and releasing of vacuum is repeated three times.

Clause 28. The method of clause 23, wherein the application of vacuum and releasing of vacuum is repeated four times.

Clause 29. The method of clause 23, wherein the application of vacuum and releasing of vacuum is repeated five times.

Clause 30. The method of clause 23, wherein the application of vacuum and releasing of vacuum is repeated until the cane reeds immersed in the solution are substantially saturated with the solution.

Clause 31. The method of clauses 9-30, wherein bubbles are observed from the cane reeds in the solution during vacuum application.

Clause 32. The method of clause 31, wherein the rate of bubbles released from the cane reeds immersed in the solution during vacuum application decreases from one repetition of vacuum application and release to the next.

Clause 33. The method of clauses 9-32, wherein the applied vacuum is less than 50 torr and the vacuum is released to less than atmospheric pressure.

Clause 34. The method of clause 33, wherein the applied vacuum is about 10 torr.

Clause 35. The method of clause 33, wherein the applied vacuum is between about 10 torr and 50 torr.

Clause 36. The method of clause 33, wherein the applied vacuum is released to between about 15 torr to about 50 torr and then optionally further released to atmospheric pressure.

Clause 37. The method of clause 32, wherein the rate of bubbles released from the cane reeds immersed in the solution during vacuum application and release of vacuum is substantially less than the rate of bubbles released from the reeds during the first vacuum application and first vacuum release.

Clause 38. The method of clause 37, wherein the applied vacuum is released to a vacuum of between about 30 torr and about 50 torr and then optionally further released to atmospheric pressure.

Clause 39. The method of clauses 1-38, wherein the humectant is a hydrophilic material.

Clause 40. The method of clause 39, wherein the humectant has a vapor pressure less than the vapor pressure of water.

Clause 41. The method of clauses 1-40, wherein the humectant is selected from the group consisting of propylene glycol, glycerol, diethylene glycol, carboxymethylcellulose, pectin, aqueous solutions of sugars, high fructose corn syrup, sorbitol, monosaccharides, disaccharides, alpha-hydroxy carboxylic acids, egg components, glycerol esters, honey, molasses, and polyols.

Clause 42. The method of clauses 1-41, wherein the humectant is glycerol.

Clause 43. The method of clauses 1-42, wherein the solution further comprises an oral antiseptic agent.

Clause 44. The method of clauses 1-43, wherein the diluent is a hydrophilic material.

Clause 45. The method of clause 1-44, wherein the diluent has a higher vapor pressure than the humectant.

Clause 46. The method of clauses 1-45, wherein the diluent is preferentially evaporated with respect to the humectant.

Clause 47. The method of clause 46, wherein the diluent has a higher vapor pressure than water.

Clause 48. The method of clauses 1-47, wherein the diluent is selected from the group consisting of one or more of ethanol, methanol, methyl formate, methyl acetate, ethyl acetate, and isopropanol.

Clause 49. The method of clause 48, wherein the diluent is ethanol.

Clause 50. The method of clause 49, wherein the diluent comprises ethanol and water.

Clause 51. The method of clauses 2 and 4-50, further comprising the step of removing excess solution from the cane reeds after isolating the cane reeds from the solution.

Clause 52. The method of clauses 3 and 4-50 further comprising the step of removing excess solution from the cane reeds after removing the cane reeds from the solution

Clause 53. The method of clauses 4-52, wherein at least some residual diluent is evaporated by drying in air.

Clause 54. The method of clause 53, wherein the drying is at ambient temperature.

Clause 55. The method of clauses 4-54, wherein the evaporation of the diluent does not substantially remove humectant within the cane reeds.

Clause 56. The method of clauses 4-55, wherein the evaporation of diluent is done at a temperature above ambient temperature.

Clause 57. The method of clauses 4-56, wherein the evaporation of diluent occurs at a temperature between about 30° C. and about 50° C.

Clause 58. The method of clauses 4-57, wherein the cane reeds are immersed in the solution at ambient temperature.

Clause 59. The method of clauses 7-58, wherein the pressure differential is applied at ambient temperature.

Clause 60. The method of clauses 1-59, wherein the cane reeds are immersed in the solution at a temperature above ambient temperature.

Clause 61. The method of clauses 7-58 and 60, wherein the pressure differential is applied at a temperature above ambient temperature.

Clause 62. The method of clause 7, wherein the pressure differential is achieved by applying pressure to the cane reeds immersed in the solution.

Clause 63. The method of clause 62, wherein the pressure is released.

Clause 64. The method of clauses 1-63, wherein the solution further comprises a defoaming agent.

Clause 65. The method of clause 64, wherein the defoaming agent is selected from the group consisting of polydimethylsiloxane oil and a silicone.

Clause 66. The method of clause 64, wherein the defoaming agent is a mixture of polydimethylsiloxane oil and silica.

Clause 67. The method of clauses 61 and 64-66, wherein the vacuum is released by ingress of air.

Clause 68. The method of clauses 9-66, wherein the vacuum is released by ingress of nitrogen.

Clause 69. The method of clauses 9-66 wherein the vacuum is released by ingress of argon.

Clause 70. The method of clauses 53-57 wherein the drying is done in a chamber.

Clause 71. The method of clause 70, wherein the chamber circulates air.

Clause 72. The method of clause 71, wherein the air is heated.

Clause 73. The method of clauses 70-72, wherein the chamber is temperature controlled.

Clause 74. A reed treated by the methods of clauses 1-73.

Clause 75. A musical instrument comprising one or more cane reeds treated by the methods of clauses 1-73.

Clause 76. A method of playing a musical instrument wherein the musical instrument comprises one or more cane reeds treated by the methods of clauses 1-73.

Clause 77. The method of clauses 9-50, further comprising the step of vibrating the solution.

Clause 78. The method of clauses 9-50, wherein container holding the solution is at angle between about 10 degrees and 45 degrees from horizontal.

Clause 79. The method of clause 78, wherein the angle is between about, 25 degrees to 35 degrees from horizontal.

Clause 80. The method of clauses 53-57 and 70-73, wherein the drying is done at a rate to prevent the warping of the cane reeds.

Clause 81. The method of clauses 1-73, further comprising the step of weighing the cane reeds before immersing in the treatment solution.

Clause 82. The method of clauses 1-73, further weighing the reeds after the release of vacuum, removing reeds from reed treatment solution and drying the reeds to substantially remove the volatile diluents.

Clause 83. The method of clauses 1-73, further comprising the step of weighing down the cane reeds in the solution to maintain immersion in the solution.

Clause 84. The method of clauses 1-73, wherein more than one cane reed is in the solution.

Clause 85. The method of clauses 1-73, wherein the reed treatment solution is used once and then discarded.

Clause 86. The method of clauses 1-73, wherein the reed treatment solution is used more than once, with or without addition of one or more components that have been depleted through prior use.

Clause 87. A cane reed treatment solution comprising water, a humectant, and ethanol.

Clause 88. The reed treatment solution of clause 87, substantially free of hydrogen peroxide.

Clause 89. The reed treatment solution of clause 88, further comprising a defoaming agent.

Clause 90. The method of clause 89, wherein the defoaming agent comprises polydimethylsiloxane oil.

Clause 91. The reed treatment solution of clause 36, wherein the defoaming agent comprises polydimethylsiloxane oil.

Clause 92. The reed treatment solution of clause 91, wherein the defoaming agent further comprises silica.

Clause 93. The reed treatment solution of clause 92, wherein the defoaming agent is a mixture of polydimethylsiloxane oil and silica.

Clause 94. The reed treatment solution of clauses 87-93, wherein the viscosity is between 1 centipoise and 150 centipoise.

Clause 95. The reed treatment solution of clause 94, wherein the viscosity is between 1 centipoise and 10 centipoise.

Clause 96. The reed treatment solution of clause 94, wherein the viscosity is between 10 centipoise and 20 centipoise.

Clause 97. The reed treatment solution of clause 94, wherein the viscosity is between 20 centipoise and 30 centipoise.

Clause 98. The reed treatment solution of clause 94, wherein the viscosity is between 30 centipoise and 40 centipoise.

Clause 99. The reed treatment solution of clause 94, wherein the viscosity is between 40 centipoise and 50 centipoise.

Clause 100. The method of clauses 1-73 or 76-83, wherein the viscosity of the solution is between 1 centipoise and 150 centipoise.

Clause 101. The method of clause 100, wherein the viscosity of the solution is between 1 and 50 centipoise.

Clause 102. The method of clause 100, wherein the viscosity of the solution is between 1 centipoise and 10 centipoise.

Clause 103. The method of clause 100, wherein the viscosity of the solution is between 10 centipoise and 20 centipoise.

Clause 104. The method of clause 100, wherein the viscosity of the solution is between 20 centipoise and 30 centipoise.

Clause 105. The method of clause 100, wherein the viscosity of the solution is between 30 centipoise and 40 centipoise.

Clause 106. The method of clause 100, wherein the viscosity of the solution is between 40 centipoise and 50 centipoise.

Clause 107. The solution of clause 87, wherein the humectant is a hydrophilic material.

Clause 108. The solution of clause 87, wherein the humectant has a vapor pressure less than the vapor pressure of water.

Clause 109. The solution of clause 87, wherein the humectant is selected from the group consisting of propylene glycol, glycerol, diethylene glycol, carboxymethylcellulose, pectin, aqueous solutions of sugars, high fructose corn syrup, sorbitol, monosaccharides, disaccharides, alpha-hydroxy carboxylic acids, egg components, glycerol esters, honey, molasses, and polyols.

Clause 110. The solution of clause 87, wherein the humectant is glycerol.

Clause 111. The solution of clause 87, wherein the solution further comprises an oral antiseptic agent.

Clause 112. The solution of clause 87, wherein the diluent is a hydrophilic material.

Clause 113. The solution of clause 87, wherein the diluent has a higher vapor pressure than the humectant.

Clause 114. The solution of clause 87, wherein the diluent is preferentially evaporated with respect to the humectant.

Clause 115. The solution of clause 87, wherein the diluent has a higher vapor pressure than water.

Clause 116. The solution of clause 87, wherein the diluent is selected from the group consisting of one or more of ethanol, methanol, methyl formate, methyl acetate, ethyl acetate, and isopropanol.

Clause 117. The solution of clause 87, wherein the diluent is ethanol.

Clause 118. The solution of clause 87, wherein the diluent comprises ethanol and water.

Clause 119. The solution of clause 109, wherein the polyol is selected from the group consisting of polydextrose, bark extracts, xylitol, mannitol, and maltitol.

Clause 120. The method of clause 41, wherein the polyol is selected from the group consisting of polydextrose, bark extracts, xylitol, mannitol, and maltitol.

### EXAMPLES

### Example 1

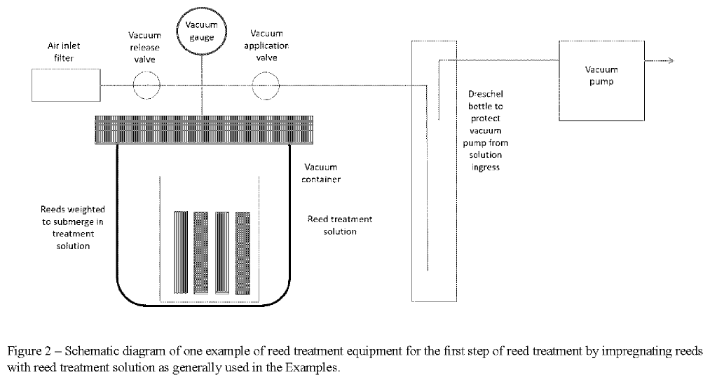

Reed treatment solution was prepared by combining 192 ml of food grade glycerol, 60 ml of Listerine Ultraclean™ antiseptic mouthwash solution (having composition with about 75% water) and 48 ml of 40% v/v ethanol in water (for which commercial Tito's™ vodka was used having about 60% water) which is substantially free of hydrogen peroxide. This reed treatment solution therefore comprised primarily around 64% v/v glycerol, around 25% water and around 6.5% ethanol plus the proprietary components present in Listerine™ antiseptic mouthwash. Solution homogeneity was achieved by gently swirling the mixture to minimize air entrainment that otherwise occurs with vigorous shaking with air present in the mixture container headspace. The viscosity of the mixture (as measured 1 day later by Brookfield DV-I PRIME viscometer instrument with LVDV-I PRIME spring torque and CPA-40 cone) was 32.5 centipoise at 1 rpm and 22.1° C. and 33.1 centipoise at 2 rpm and 22.1° C. The solution at ambient temperature of around 20° C. was “degassed” by placing it in a sealed chamber and applying increasing vacuum steadily up to around 28 inches Hg vacuum gauge reading over a period of 1-2 minutes, until dissolved air bubbling had substantially eased off. Vacuum was slowly released by opening the valve to let air into the air chamber over about 1 minute. About 250 ml of this reed treatment solution was dispensed into an open-necked flask, beaker or jug with sufficient depth to fully immerse the size of the reeds to be treated, with beaker height chosen to also fit within the vacuum chamber used for reed treatment (See FIG. 2). Commercial musical instrument reeds (e.g. clarinet reeds, saxophone reeds or other reeds) were immersed into the reed treatment solution and kept immersed by caging into weighted cages (or in another example the reeds were themselves weighted by attaching metal paper clips to the reeds), sufficient to cause the reeds to sink in the reed treatment solution. Any number of reeds could be treated at a time provided they all fitted into the container with the reed treatment solution, fully immersed in the reed treatment solution and without significantly occluding one another (i.e. without preventing solution access all around the reed), typically between 4 and 6 reeds could be comfortably accommodated within the 250 ml of reed treatment solution in the beaker used that fitted into the vacuum chamber.

FIG. 2 is a diagram showing the apparatus used to treat the reeds as disclosed herein. The container (an open necked beaker or flask) holding the reeds submerged in the reed treatment solution was placed into the vacuum chamber and vacuum was gradually but steadily applied, resulting in substantial bubbling and frothing as the channels in the reeds were evacuated, releasing their gaseous contents into the reed treatment solution. The rate at which vacuum was applied, by careful control of the valve connecting the vacuum chamber to the vacuum pump, was controlled so as to manage the rate at which bubbles and frothing of the reed treatment solution occurred, endeavoring to minimize overflow of froth from the open necked beaker or flask containing the reeds. A dreschel bottle was included in the line between the vacuum chamber and the vacuum pump to prevent any reed treatment solution being sucked into the vacuum pump. Full vacuum of 28 inches Hg gauge reading was established in the vacuum chamber containing the reeds in the reed treatment solution using a Zeny single stage vacuum pump having free air displacement capacity of 3.5 cubic feet per minute, capable of pumping down to 0.05 mbar pressure. This was connected by rubber or Teflon vacuum tubing to a 14 cm diameter stainless steel vacuum chamber made by Ablaze capped with acrylic lid equipped with vacuum gauge. The vacuum was maintained for 5 minutes, during which time the chamber was gently tapped and gently shaken to dislodge any bubbles adhering to the reeds being treated that were buoying the reeds, this helped the reeds sink again back into the reed treatment solution so that the reeds were substantially or fully immersed in the reed treatment solution. Over the course of the vacuum treatment duration of 5 minutes, the vacuum measured by the gauge on the vacuum chamber rose from 28 inches of Hg gauge reading to 28.5 inches of Hg gauge reading. After the 5 minutes of vacuum application, vacuum was then released by closing the valve to the vacuum pump and carefully, cautiously and slowly opening the valve to atmospheric air, filtered by an inline filter, so as to allow the pressure in the vacuum chamber to rise at a slow even rate back to atmospheric pressure over a period of 60 to 90 seconds. Once atmospheric pressure was reestablished in the chamber, the reed treatment solution was topped up from the surplus solution prepared earlier to replenish any reed treatment solution that was lost from the open necked flask into the vacuum chamber due to reed treatment solution bubbling and frothing if vacuum was applied too quickly. The reed treatment solution flask was tapped and gently swirled to displace any bubbles adhering to the reeds and to ensure all reeds were fully immersed. The reeds were held in the solution at atmospheric pressure for 1 to 2 minutes from the time that vacuum was fully released. At that time vacuum was again applied carefully and slowly for a second iteration of the vacuum treatment at such a rate as to again avoid excessive bubbling and loss of froth from the open necked flask containing the reed treatment solution and the reeds within the vacuum container although bubbling and frothing was attenuated with the second vacuum application compared with the first. Once full vacuum was achieved it was again maintained for 5 minutes with occasional tapping or gentle swirling of the equipment to displace any bubbles buoying the reeds. After 5 minutes of vacuum application the vacuum gauge in the vacuum chamber again read 28.5 inches Hg of vacuum. Vacuum was then again released slowly and evenly over the course of 60-90 seconds, the reed treatment solution was again topped up from the originally prepared solution to ensure complete reed submersion, the reeds were held in the reed treatment solution at atmospheric pressure again for 1-2 minutes and vacuum was again applied a third time. The amount of bubbling and frothing was much less with the third vacuum application which indicated that the channels within the reed were by this time substantially evacuated of air as it is the air entrained within the reed that causes the bubbling and frothing as vacuum is applied. Vacuum of 28.5 inches Hg measured by the gauge on the vacuum chamber was again maintained for 5 minutes with occasional tapping and swirling again to release any bubbles buoying the reeds although there were little by this time of the third vacuum iteration. Vacuum was then released very slowly and evenly over the course of 90 seconds and the reeds were left immersed in the reed treatment solution at atmospheric pressure for 2 minutes to force the reed treatment solution into the remaining channels and cavities within the reeds that had been evacuated by the reiterated vacuum treatment. Optional further iterations of the vacuum application and vacuum release as described above were also evaluated and found to be helpful with other reed treatment solution compositions and with larger reeds, but it was found that 3 iterations with reed treatment solution composition as described in this example were sufficient with Bb clarinet reeds to achieve efficient reed permeation by the reed treatment solution, as evidenced by substantial cessation of bubbling and frothing by the time of third iteration of the vacuum treatment and also as evidenced by monitoring weight increase of the reeds, both when wet at the end of the treatment with the reed treatment solution and also later after the second step of evaporative drying to remove the excess water and ethanol solvents, leaving primarily the humectant that had been dissolved in the solvents in the reed treatment solution. The weights of untreated Bb clarinet reeds typically increased by about 20% after reed treatment solution processing as described in this example followed by simple passive drying by leaving on a tissue platform in still air at ambient temperature of around 20° C. and 60% RH for 2 hours. After further drying in actively circulated warmed air at around 32° C. for further 15 hours the weight increase compared to the original weight of the untreated commercial Bb clarinet reeds was about 10% to 12%.

Passive air drying for between 24 hours and 48 hours on a bed of tissue paper out of direct sunlight was sufficient on warm and dry days (with ambient conditions around 20° C. to 25° C. and RH less than 50%) to achieve evaporation of much or most of the solvent leaving primarily the humectant lodged in the reed channels. A more reliable method for consistent evaporation of much of the ethanol and water solvents present in the reeds whilst leaving humectant and not over drying or too rapidly drying reeds (which can cause reed warping) was to use gently heated circulated air. Thus, after completion of reed treatment using reed treatment solution as described above, the reeds were unloaded from the reed treatment solution apparatus, weights were removed, the reeds were gently wiped dry of extraneous reed treatment solution using dry tissue paper, the reeds were left to air dry on a bed of tissue paper out of direct sunshine at around 20° C. and 60% RH for 2 hours, the reeds were then loaded into the third tier from the bottom of 4 tiers of drying stages in a Presto 06301 Dehydro Digital Electric Food Dehydrator and the dehydrator was set to circulate gently heated air at 90 F (circa 32° C.) for 15 hours with ambient humidity around 50% RH to 60% RH. Longer drying in the food dehydrator was also effective (up to 35 hours in total) but gave increased frequency of reed warping. Control of surrounding humidity achieves faster evaporation requiring less drying time with weight increase compared with original untreated reed weight providing monitoring of the extent of drying (which depends on humidity, size of reeds and the composition of the reed treatment solution used). The targeted weight increase from original reed weight before treatment, for good reed performance, ranged between 8% and 14%. On completion of drying, reeds were packaged and kept protected from direct sunlight, excessive heat or high humidity before use in musical practice and performance.

### Example 2

In the same way as described in Example 1, bass clarinet reeds were treated but using an increased quantity of reed treatment solution to ensure full immersion of the longer reeds compared with Bb clarinet reeds.

### Example 3

Following essentially the same procedure as described in Example 1, propylene glycol was substituted for glycerol.

### Example 4

Following essentially the same procedure as described in Example 1, the reed treatment solution comprised 80% v/v propylene glycol and 20% v/v Tito's™ vodka.

### Example 5

Following essentially the same procedure as described in Example 1, the reed treatment solution comprised 80% v/v glycerol and 20% v/v Tito's™ vodka.

### Example 6

Following essentially the same procedure as described in Example 1, the reed treatment solution comprised 50% v/v glycerol and 50% v/v Tito's™ vodka.

### Example 7

Following essentially the same procedure as described in Example 1, the reed treatment solution comprised 20% v/v glycerol and 80% v/v Tito's™ vodka but this gave little net weight increase after treatment implying little humectant retention due to over dilution by solvents evaporated during reed drying.

### Example 8

Following essentially the same procedure as described in Example 1, the reed treatment solution comprised 50% v/v propylene glycol and 50% v/v Tito's™ vodka.

### Example 9

Following essentially the same procedure as described in Example 1, the reed treatment solution comprised 20% v/v propylene glycol and 80% v/v Tito's™ vodka but this gave little net weight increase after treatment implying little humectant retention due to over dilution by solvents evaporated during reed drying.

### Example 10

Following essentially the same procedure as described in Example 1, the reed treatment solution comprised 75% v/v propylene glycol and 25% v/v Tito's™ vodka.

### Example 11

Following essentially the same procedure as described in Example 1, the reed treatment solution comprised 75% v/v propylene glycol and 25% v/v Tito's™ vodka.

### Example 12

Following essentially the same procedure as described in Example 1, the reed treatment solution comprised 70% v/v glycerol, 15% Corsodyl™ (chlorhexidine digluconate antiseptic mouthwash formulation) and 15% v/v Tito's™ vodka.

### Example 13

Following essentially the same procedure as described in Example 1, the reed treatment solution comprised 60% v/v glycerol, 15% Corsodyl™ (chlorhexidine digluconate antiseptic mouthwash formulation) and 25% v/v Tito's™ vodka.

### Example 14

The reed treatment solution left from Example 1 was reused following the same procedure as described in Example 1 but with reuse of the previously used reed treatment solution for a further batch of reeds.

### Example 15

In the same way as described in Example 1, the reed treatment solution was prepared but was forced into reed vasculature not by reiterated vacuum and atmospheric pressure application cycling of Example 1 but instead by using a tightly fitting sealed tubing clamped around the butt of the reed with pressurized delivery used to force the reed treatment solution into and through the reed. The solution may also be forced into the reed in a similar fashion by clamping the tubing round the vamp end of the reed. Pressure of between 1 and 20 psig was applied for 10 minutes to force reed treatment solution into the reed before continuing with the drying procedure described in Example 1.

### Example 16

In the same way as described in Example 1, the reed treatment solution was forced into reed vasculature not by reiterated vacuum and atmospheric application cycling of Example 1 but instead by holding the reeds immersed in reed treatment solution in a pressure chamber and applying externally applied pressure using a pump or a gas cylinder containing nitrogen or containing air, increasing pressure up to 1 barg, holding 1 barg for 10 minutes and then very slowly releasing pressure over the period of 5 minutes before reiterating the cycle between 2 and 8 times until no more increase in reed weight could be achieved. The drying procedure described in Example 1 then followed.

### Example 17

12 commercial Vandoren V12 Bb clarinet 3.5 reeds and D'Addario Reserve Classic Bb clarinet 3.5+strength reeds were randomly numbered with unique three digit codes. Two reeds from each of the two different manufacturers were treated according to the principles of the present disclosure (Example 1). The rest of the reeds were variously just dipped in the reed treatment solution for 9 minutes or simply wiped with the reed treatment solution. The reeds were supplied to a professional musician without disclosure of which treatment was applied to each reed. Over a period of around 2 weeks of reed use, the professional musician then reported back with comments on each reed and judgement on whether the reed behaved as a reed treated according to the principles of this present disclosure (in terms of superior musical performance) or whether it behaves as if it had not been treated according to the principles of this present disclosure. Of these 12 mixed Vandoren 3.5 reeds and D'Addario 3.5+ reeds the professional musician was able to identify with 93% accuracy which reeds were treated and which were not treated according to the principles of the present disclosure by evaluation of reed performance, ease of use and tone.

### Example 18

Solution: 192 ml of food grade glycerol, 60 ml of Listerine Ultraclean™, 48 ml of Tito's™ vodka were gently swirled in a corked flask to achieve homogeneity with minimal entrainment of air. About 250 ml of this solution was dispensed into an open-necked beaker, enough to fully immerse and treat 4-6 reeds. Reeds need to remain submerged throughout processing either by individual weights or a metal screen to maintain the reeds below liquid surface in beaker.

Reed preparation: Reeds to be treated were weighed using a precision weighing device and the weight of each reed was noted on back of each reed in pencil. Reed weights were also recorded in a logbook. The individual reeds were placed in protective holders and immersed in the treatment beaker. This beaker with submerged reeds was placed into the vacuum chamber.

Treatment: 1. Vacuum was slowly applied over a period of about two to three minutes to reach 28-29 Hg of vacuum within the reed treatment unit. Significant frothing occurs to start with which necessitates mitigation of the rate at which vacuum is applied in order to control the rate of frothing of the solution around the reeds. Lowering pressure too rapidly or lowering below 29 Hg is likely to result in warping of reeds after completion of treatment. 2. Vacuum valve was adjusted as needed to maintain steady, controlled bubbling from the reeds for 5 additional minutes, tapping or vibrating the reed treatment chamber was employed to dislodge bubbles from the reeds. 3. Close valve to pump, break vacuum, turn off pump. Slowly let air into chamber. 1′-1.5′0.4. Let reeds remain for 2′ at atmospheric pressure. 5. Repeat process steps 1-4 for a second treatment. 6. Repeat process steps 1-4 for a third treatment. Top-off beaker with fresh solution if needed. Drying: Unload reeds from the reed treatment solution. Gently wipe dry. Weigh reeds and record weight. (=˜20%) Let reeds air dry out of direct sunshine for 2 hours. Load reeds into the third tier from the bottom of 4 tiers of drying stages in Food Dehydrator Set it to circulate gently heated air at 90 F for 15 hours. Weigh reeds and record (=˜+8%-14% from original weight) Place reeds in protective sleeves and let rest 24 hours before playing. *General Vacuum Use Procedure: Vent exhaust line on pump outdoors, being careful not to crimp. To start: Valve to air open. Valve to pump closed. Start pump, close inlet valve on chamber, open valve on line to pump very slowly and cautiously. To stop: Close outlet valve to pump, break vacuum (bleed valve), turn off pump, open air inlet valve to chamber very slowly and cautiously.

### Example 19

A mixture of glycerol (192 ml), Listerine Ultraclean mouthwash (60 ml) and Tito's vodka (48 ml) was mixed gently by swirling and repeated inversion and uprighting in a sealed bottle. The mixture was allowed to settle for 5 minutes and was then dispensed into a glass container within a vacuum chamber device. Two tenor saxophone reeds were immersed into this reed treatment solution, held loosely within reed holders cut to allow free flow of treatment solution around the reeds and weighted down with steel weights so that reeds and reed holders were kept immersed below the surface of the reed treatment solution. The glass container within the vacuum chamber was placed on a small block within the vacuum chamber so as to tilt the glass chamber about 10 degrees from horizontal. The lid of the vacuum chamber was then placed on the vacuum chamber and the vacuum chamber was itself placed on a small block so as to further tilt the glass container and the reeds it contained to about 30 degrees from horizontal. The purpose of the tilt from horizontal was to assist in release of bubbles from the surface of the reeds as vacuum was applied so that those bubbles were no longer present when vacuum was subsequently broken, this was to prevent the air from the bubbles being reabsorbed by the reeds as vacuum was broken. Vacuum of 28.5 inches of mercury was slowly and gradually applied over a period of 1 minute, this resulted in significant frothing as small bubbles of air were sucked out from the reeds. The vacuum chamber was tapped and swirled gently to help displace bubbles from the reeds, helped by the angle of inclination from the horizontal at which the reeds and the vacuum chamber was maintained. The vacuum was maintained for a period of 5 minutes at ambient temperature of 62 F. The vacuum chamber was then sealed from the vacuum pump by closing the valve connecting the vacuum chamber to the vacuum pump. The vacuum line was disconnected opening the line to the vacuum pump to atmosphere and the vacuum pump was then switched off. The valve connecting the vacuum chamber to atmosphere through an inline filter was then opened very slowly and carefully so as to allow ingress of air into the vacuum chamber, through the inline filter to cause the vacuum in the vacuum chamber to drop at an approximately even controlled rate over a period of 1 minute. The apparatus comprising vacuum chamber and reeds in treatment solution was tapped, the treatment solution in the glass container holding the reeds immersed in treatment solution, was topped up with the treatment solution prepared earlier to replace solution that had frothed out of the glass container into the vacuum chamber and the evacuation process described above was repeated a second time. This resulted in less frothing of the reeds in the reed treatment solution than occurred with the first vacuum application. Vacuum was again released as described above. This procedure of slow evacuation over a minute, holding under 28.5 inches of mercury gauge-vacuum for 5 minutes, tapping to dislodge bubbles and slow release of vacuum over a minute, followed by holding at atmospheric pressure for 3-5 minutes was repeated until the extent of bubbling and frothing when vacuum was applied had eased considerably which took a total of 5 iterations. The reeds were then removed from the solution, gently wiped dry of solution with dry tissue paper and placed on dry tissue paper in the air at 62 Fahrenheit temperature and 50% relative humidity for 9 hours. The reed treatment solution was replaced with fresh reed treatment solution made from 211 ml glycerol, 66 ml of Listerine Ultraclean mouthwash and 52.8 ml of Tito's vodka gently mixed together with minimal air entrainment and four further Tenor Saxophone reeds were treated in the same way as described above for which 5 iterations of the slow vacuum application and slow vacuum release were again needed to achieve diminution of frothing on evacuation. All 6 treated and air dried reeds were then loaded into a food desiccator apparatus and dried at 90 Fahrenheit under forced air stream in the food desiccator for 20 hours in room conditions comprising 47% relative humidity and 69 Fahrenheit room air. The 6 reeds were unloaded from the food desiccator and reweighed.

The reeds were weighed at different stages through the course of the process to track treatment solution uptake and progress of drying with results as follows:

| | | Weight after | Weight after 10 h | Weight after 16 h |
|---|---|---|---|---|
| | Weight | treatment and | of drying in food | of drying in food |
| | before | air drying | desiccator at 90 | desiccator at 90 F. |
| | treat- | (g) followed by | F. (g) followed by | (g) followed by |
| Reed | ment | overall weight | overall weight | overall weight |
| # | (g) | change % | change % | change % |
| 1 | 1.33 | 1.54 (+16%) | 1.49 (+12%) | 1.46 (+10%) |
| 2 | 1.36 | 1.62 (+19%) | 1.55 (+14%) | 1.53 (+12.5%) |
| 3 | 1.40 | 1.61 (+15%) | 1.54 (+10%) | 1.53 (+9%) |
| 4 | 1.29 | 1.50 (+16%) | 1.44 (+12%) | 1.42 (+10%) |
| 5 | 1.34 | 1.56 (+16%) | 1.47 (+10%) | 1.48 (+10%) |
| 6 | 1.31 | 1.51 (+15%) | 1.43 (+9.2%) | 1.42 (+8%) |

### Example 20

In the same way as above, two lots of six D'Addario clarinet reeds were treated with the same reed treatment solutions as was used in the previous example (six reeds per treatment, with everything repeated for the second set of six reeds). A series of 3 vacuum and vacuum break cycles were employed to achieve saturation of the reeds with the reed treatment solution as evidenced by lessening of bubbling during the vacuum applications. These reeds were air dried for six hours at 69 Fahrenheit and 55% relative humidity. They were then transferred to a food desiccator apparatus and dried at 90 Fahrenheit, the surrounding ambient air was 69 Fahrenheit and 64% relative humidity. The reeds were taken out of the food desiccator and weighed after 2.5 hours. At that time their weight was between 12% and 20% higher than their original weights before initiation of treatment (in other words before immersion in reed treatment solution). The average weight increase after treatment with reed treatment solution, air during for six hours and drying in the food desiccator at 90 Fahrenheit for 2.5 h was 15% weight gain compared with average weight before treatment. The drying of the reeds was continued in the food desiccator at 90 Fahrenheit for a total drying time of 16 hours. The weight gain of the reeds after that duration of drying time in the food desiccator compared to their weights before treatment was between 5% and 11% weight gain with an average weight gain for the reeds after completion of drying of 7.6%.

### Example 21

Following the same procedure as described in Example 1 but with release of vacuum using nitrogen gas rather than air.

1. A method of treating musical instrument cane reeds comprising the step of immersing cane reeds in a solution comprising a humectant and at least one diluent, wherein a pressure differential is applied between the reeds and the solution, wherein the pressure differential is achieved by applying a vacuum to the reeds immersed in the solution followed by releasing the vacuum, and wherein the pressure differential is applied in a cyclic manner over various time courses.

2-3. (canceled)

4. The method of claim 1, further comprising the steps of removing the cane reeds from the solution and evaporating at least some of the residual diluent from the cane reeds.

5-9. (canceled)

10. The method of claim 1, wherein the release of vacuum occurs by exposing the reeds immersed in the solution to atmosphere.

11. The method of claim 1, wherein the vacuum is applied over a period of from about 10 seconds to about 5 minutes.

12. (canceled)

13. The method of claim 11, wherein after the vacuum application is complete, the vacuum is maintained for between about 10 seconds to about 10 minutes.

14-16. (canceled)

17. The method of claim 1, wherein the vacuum is released over a period of between about 10 seconds to about 5 minutes.

18. (canceled)

19. The method of claim 1, wherein the absolute pressure over the reeds immersed in the solution is less than about 75 torr.

20-21. (canceled)

22. The method of claim 19, wherein the absolute pressure of the reeds immersed in the solution is between about 10 torr and about 50 torr.

23. The method of claim 1, wherein the application of vacuum and releasing of vacuum is repeated.

24-29. (canceled)

30. The method of claim 23, wherein the application of vacuum and releasing of vacuum is repeated until the cane reeds immersed in the solution are substantially saturated with the solution.

31. The method of claim 23, wherein bubbles are observed from the cane reeds in the solution during vacuum application, and wherein the rate of bubbles released from the cane reeds immersed in the solution during vacuum application decreases from one repetition of vacuum application and release to the next.

32-40. (canceled)

41. The method of claim 1, wherein the humectant is selected from the group consisting of propylene glycol, glycerol, diethylene glycol, carboxymethylcellulose, pectin, aqueous solutions of sugars, high fructose corn syrup, sorbitol, monosaccharides, disaccharides, alpha-hydroxy carboxylic acids, egg components, glycerol esters, honey, molasses, and polyols.

42. The method of claim 41, wherein the humectant is glycerol.

43. The method of claim 1, wherein the solution further comprises an oral antiseptic agent.

44-47. (canceled)

48. The method of claim 1, wherein the diluent is selected from the group consisting of one or more of ethanol, methanol, methyl formate, methyl acetate, ethyl acetate, and isopropanol.

49. The method of claim 48, wherein the diluent is ethanol.

50-52. (canceled)

53. The method of claim 4, wherein at least some residual diluent is evaporated by drying in air.

54. (canceled)

55. The method of claim 4, wherein the evaporation of the diluent does not substantially remove humectant within the cane reeds.

56. (canceled)

57. The method of claim 4, wherein the evaporation of diluent occurs at a temperature between about 30° C. and about 50° C.

58-61. (canceled)

62. The method of claim 1, wherein the pressure differential is achieved by applying pressure to the cane reeds immersed in the solution.

63-86. (canceled)

87. A cane reed treatment solution comprising a humectant and a diluent,
wherein the humectant has permeation properties to permeate into and within the fabric of the reed, wherein the diluent may include one or more optional solvents to improve the permeation properties of the humectant,
wherein a pressure differential can be applied between the reed and the solution to improve the permeation properties of the humectant,
wherein the treatment solution renders an improved cane reed performance.

88-100. (canceled)

101. The method of claim 1, wherein the viscosity of the solution is between 1 and 50 centipoise.

102-121. (canceled)
